(19) United States
(12) Patent Application Publication
(10) Pub. No.: US 2021/0365823 A1
(43) Pub. Date: Nov. 25, 2021

(54) CAPACITY EVALUATION METHOD AND DEVICE BASED ON HISTORICAL CAPACITY SIMILARITY CHARACTERISTIC

(71) Applicant: THE 28TH RESEARCH INSTITUTE OF CHINA ELECTRONICS TECHNOLOGY GROUP CORPORATION, Nanjing (CN)

(72) Inventors: Bin DONG, Nanjing (CN); Yongjie YAN, Nanjing (CN); Shucheng SHI, Nanjing (CN); Ke DENG, Nanjing (CN); Ming TONG, Nanjing (CN); Yi MAO, Nanjing (CN); Yang ZHANG, Nanjing (CN); Jibo HUANG, Nanjing (CN); Shenghao FU, Nanjing (CN); Shane XU, Nanjing (CN); Yao SHAN, Nanjing (CN)

(21) Appl. No.: 17/444,326

(22) Filed: Aug. 3, 2021

Related U.S. Application Data
(63) Continuation-in-part of application No. PCT/CN2021/073815, filed on Jan. 26, 2021.

(30) Foreign Application Priority Data
Apr. 29, 2020 (CN) 202010356418.1

(51) Int. Cl. G06N 7/02; G06K 9/62; G08G 5/00

(52) U.S. Cl. CPC G06N 7/023; G06K 9/6272; G08G 5/003; G06K 9/6239; G06K 9/6215

(57) ABSTRACT

A method accurately evaluates a corresponding operation capacity for an operating characteristic of a to-be-evaluated object in a to-be-evaluated time period in combination with already-operated historical data of the to-be-evaluated object, which specifically includes: for a capacity influence factor in an operating process of an airspace unit, constructing a capacity similarity characteristic model to form a capacity similarity characteristic index set; acquiring historical data of an evaluation object, on the basis of the capacity similarity characteristic index set, classifying historical data samples of different time periods by a clustering algorithm, and generating a capacity similarity time period sample set to which an evaluation time period of the current evaluation object belongs; and classifying historical capacity values of the capacity similarity time period sample set by a density clustering algorithm, and calculating a capacity reference value on the basis of a maximum class cluster.

### TECHNICAL FIELD

The present invention relates to the field of air traffic control automation technologies, and more particularly, to a capacity evaluation method and device based on a historical capacity similarity characteristic.

### BACKGROUND

A capacity evaluation technology is an important component of air traffic control, and an accuracy of capacity evaluation directly affects an efficiency of airspace operation and an execution effect of a control decision-making measure. A maximum traffic that a system can bearing may be determined through the capacity evaluation, which is one of main bases for traffic control. Meanwhile, the capacity evaluation is also an important content of airspace planning, and it is an important measure to effectively use an airspace resource to propose optimization and improvement schemes for an airspace structure through the capacity evaluation.

At present, there are four main capacity evaluation methods: an evaluation method based on a workload of a controller, an evaluation method based on historical statistical data analysis, an evaluation method based on a mathematical calculation model, and an evaluation method based on computer simulation, wherein how to acquire a capacity reference value of a to-be-evaluated object through historical data analysis is a hot issue currently. At present, an envelope analysis method is mainly used for the capacity evaluation based on historical data, and by sorting and screening a sample set with a fixed-length, a capacity value is acquired based on a distribution characteristic of the sample set. The capacity value reflects a macro set characteristic, the selection of the sample set has a great influence on a capacity result, and a data driving property is greater than a target driving property in a use process. Moreover, the method is mainly applied to post-event capacity analysis, and lacks a capacity prediction ability for a specific evaluation scenario, so that an application field of the method is narrow.

### SUMMARY

Objective of the invention: aiming at the defects in the prior art, the present invention provides a capacity evaluation method and device based on a historical capacity similarity characteristic, which can be closer to an actual capacity change trend of an airspace unit, such as an airport, a sector, and the like, and give an accurate capacity reference value.

Technical solutions: in a first aspect, a capacity evaluation method based on a historical capacity similarity characteristic is provided, which includes the following steps of:

for a capacity influence factor in an operating process of an airspace unit, constructing a capacity similarity characteristic model to form a capacity similarity characteristic index set;

acquiring historical data of an evaluation object, on the basis of the capacity similarity characteristic index set, classifying historical data samples of different time periods by a clustering algorithm, and generating a capacity similarity time period sample set to which an evaluation time period of the current evaluation object belongs;

classifying historical capacity values of the capacity similarity time period sample set by a density clustering algorithm, and calculating a capacity reference value on the basis of a maximum class cluster; and

adjusting the capacity of an airspace structure.

The capacity influence factor includes a structural factor, an operating factor, and an emergency factor, the structural factor is used for characterizing a relationship between a static characteristic and a capacity of the to-be-evaluated object, which refers to statistical analysis performed on the to-be-evaluated object from a perspective of a complex network after abstracting the to-be-evaluated object as a weighted network; the operating factor is used for characterizing a relationship between a dynamic characteristic and the capacity of the to-be-evaluated object, which refers to a macro operating situation of the to-be-evaluated object in a to-be-evaluated time period in a case of a specific flight plan; and the emergency factor is used for characterizing a relationship between a random characteristic and the capacity of the to-be-evaluated object, which refers to quantitative measurement on an influence of an emergency on the operation of the to-be-evaluated object.

Further, an index set of the structural factor is Des={K, P, De}, wherein a non-linear coefficient K is an mean value of a ratio of an actual flight distance to a spatial distance between an origin and a destination of a route of a flight in a statistical time period, with a calculation formula of

$$K = \frac{{\sum }_{f = 1}^{m} \frac{{\sum }_{i = 1}^{n} {d}_{fi}}{{d}_{min}}}{m} ,$$

m represents a number of flights flying in the evaluation object in the statistical time period, n represents a number of route segments through which an f^{th} flight flies, d_{fi} represents a distance of the route segment i through which the f^{th} flight flies, and dₘᵢₙ represents the spatial distance between the origin and the destination of the flight route; a node pressure P represents a mean value of a flow passing through a key point in the statistical time period, with a calculation formula of

$$P = \frac{{Σω}_{k}}{num} ,$$

ωₖ represents a flight flow passing through a way point k in unit time, and num represents a number of nodes; a mean value of a node degree De represents a complexity of an airspace structure, with a calculation formula of

$$De = \frac{{\sum }_{i}^{num} {de}_{i}}{num} ,$$

num represents a number of nodes, and deᵢ represents a number of route segments connected with a way point i;

an index set of the operating factor is Dyn={F,T_{d}}, a time period flow F refers to a number of flights entering the to-be-evaluated object in the statistical time period; an average delay time refers to a delay time of the flight in the to-be-evaluated object in the to-be-evaluated time period, with a calculation formula of

$${T}_{d} = \frac{{\sum }_{i = 1}^{F} {t}_{i}^{d}}{F} ,$$

tᵢ^{d} represents a delay time of a flight i, which is a difference between a planned flight time and an actual flight time of the flight i in the to-be-evaluated object;

an index set of the emergency factor is Out={ρ,R}, ρ represents a weather blocking degree, and R represents a capacity decrease rate; and

an index set of the capacity similarity characteristic is T={K,P,De,F,T_{d},ρ,R}.

Further, the classifying the historical data samples of different time periods by the clustering algorithm, and generating the sample set to which the evaluation time period of the current evaluation object belongs, includes: performing index statistics of different time periods on historical operation flight path data of the to-be-evaluated object and flight path data of the to-be-evaluated time period according to the capacity similarity characteristic model to form a capacity similarity characteristic index set matrix D, wherein a number of columns is a number of capacity similarity characteristic indexes, a number of rows is a number of time period samples, and a duration of the different time periods is a time granularity of capacity evaluation, and clustering the matrix D in behavior unit by the clustering algorithm to obtain a cluster to which the to-be-evaluated time period of the to-be-evaluated object belongs as a target sample set.

Preferably, a fuzzy C-means algorithm is employed as the clustering algorithm, and the classifying the capacity samples includes the following steps of:
(a) initializing parameters of the fuzzy C-means clustering algorithm:

standardizing a range of the matrix D, setting a fuzzy index m∈[1, ∞), a stable classification threshold δ∈[0,1), and a number of classification times iter∈[1,∞), and determining a number of sample classifications k; initialize a membership degree matrix U with data between (0 and 1), and meeting a constraint condition

$${\sum }_{i = 1}^{k} {u}_{ij} = 1 ,$$

∀J=1, . . . , n, wherein n is a total number of sample data;

(b) performing fuzzy C-means clustering:

according to the membership degree matrix U, obtaining a k^{th} clustering center of the classification by a formula

$${c}_{ei} = \frac{{\sum }_{j = 1}^{n} {u}_{ij}^{m} {x}_{j}}{{\sum }_{j = 1}^{n} {u}_{ij}^{m}} ,$$

(i=1, 2 . . . k), wherein xⱼ represents an element in a j^{th} row of a matrix D, obtaining a distance dᵢⱼ from n data samples to each clustering center by a Euclidean distance formula, and on the foregoing basis, calculating a value function J, with a formula of

$$J ( U , {c}_{1} , … , {c}_{k} ) = {\sum }_{i = 1}^{k} {J}_{i} = {\sum }_{i = 1}^{k} {\sum }_{j}^{n} {u}_{ij}^{m} {d}_{ij}^{2} ;$$

if a difference between a value function of the current classification result and a value function of a previous classification result is greater than a stable classification threshold δ, resetting a number of continuous stable clustering times cnt to be 0, updating the membership degree matrix U, and clustering again; and

if the difference between the value function of the current classification result and the value function of the previous classification result is less than the stable classification threshold δ, automatically increasing the number of continuous stable clustering times cnt, if cnt<iter, updating the membership degree matrix U, and clustering again; if cnt=iter, finishing the clustering algorithm, and obtaining different clusters of the historical sample data divided according to capacity similarity characteristics.

A calculation formula of the updated membership degree matrix is

$${u}_{ij} = \frac{1}{{\sum }_{x = 1}^{k} {( \frac{{d}_{ij}}{{d}_{xj}} )}^{2 \text{/} ( m - 1 )}} ,$$

and in the formula, dₓⱼ represents a Euclidean distance from a data sample in a j^{th} row to the clustering center.

As a preferred solution, in step (a), a number of classifications of capacity samples k is adaptively determined by an extreme value discrimination method, which includes the following steps of:
(1) setting a number of initialized classifications to be k=2;
(2) clustering samples to obtain k sample clusters, if k does not meet an extreme value judgment condition, automatically increasing a k value; and if k meets the extreme value judgment condition, performing extreme value judgment on the current clustering result as follows:

calculating an intra-cluster distance DI(k) and an inter-cluster distance DB(k) of each sample cluster; wherein

$$DI ( k ) = \frac{{\sum }_{c = 2}^{k} {\sum }_{i = 1}^{{n}_{k}} {d}_{ci}}{k} ,$$

d_{ci} represents a Euclidean distance between a sample Dᵢ in the same data cluster and a clustering center c_{c}, nₖ represents a number of samples in a k^{th} cluster; and

$$DB ( k ) = \frac{{\sum }_{i = 2}^{k} {\sum }_{j = 2}^{k} {d}_{ij}}{k} ,$$

dᵢⱼ represents a Euclidean distance between a clustering center cᵢ and a clustering center cⱼ; and

judging a change condition of a ratio I(k)=DB(k)/DI(k), if I(k)>I(k−1) and I(k)>I(k+1), then setting a number of clusters to be k, otherwise, automatically increasing the k value, and returning to step (2).

Further, a self-adaptive density clustering algorithm is employed as the density clustering algorithm to classify historical capacity values of a target set, which includes:
(a) calculating a cluster data barycenter set: initializing the cluster data barycenter set CenU=ϕ and an unvisited object set T, setting an initial density cluster radius ε=d±σ and a minimum number of data in neighborhood MinPts, traversing a point Gᵢ, i=1, 2, . . . num in a cluster, wherein num is a number of samples in the cluster, if a number of sample points of Gᵢ in neighborhood in a range of a cluster radius ε is greater than MinPts, setting the point Gᵢ as a cluster data barycenter point, and adding the same into the set CenU; and if the number of the sample points of Gᵢ in neighborhood in the range of the cluster radius ε is not greater than MinPts, then progressively increasing the density cluster radius, re-traversing G to find the cluster data barycenter point, and after traversing the cluster G to judge the cluster data barycenter point, allowing T=G, and executing step (b);
(b) dividing the clusters, which includes the following steps of:

(b1) if CenU=ϕ, finishing the algorithm, and executing step (c), otherwise, randomly selecting a core object o from the cluster data barycenter set CenU, updating the set CenU, CenU=CenU−{o}, initializing a current cluster sample set Cₖ={o}, allowing an object set contained in the current cluster sample set Cₖ to be Q={o}, and updating the unvisited sample set T=T−{o};

(b2) if the current cluster object set is Q=ϕ, executing step (b3); otherwise, allowing the current cluster object set to be Q≠ϕ, taking a first sample q in Q, finding out a sample set N_{ε}(q) in all neighborhoods in G through the cluster radius ε, allowing X=N_{ε}(q)∩T, adding samples in X into Q, updating the current cluster sample set Cₖ=Cₖ∪X, updating the unvisited sample set T=T−X, and executing step (b2);

(b3) after generating the current cluster Cₖ, updating cluster division C={C₁, C₂, . . . , Cₖ}, updating the set CenU=CenU−Cₖ∩CenU, and executing step (b1); and

(c) calculating a capacity value:

$$Capacity = \frac{{\sum }_{i = 1}^{num} {C}_{k}^{i}}{num} ,$$

wherein Cₖ is a cluster with the largest number of samples in the cluster division C={C₁, C₂, . . . , Cₖ}, num is a number of samples in the cluster Cₖ, and Cₖⁱ is an i^{th} element in the cluster.

In a second aspect, a computer device is provided, which includes:

one or more processors and a memory; and one or more programs, wherein the one or more programs are stored in the memory and configured to be executed by the one or more processors, and the programs, when executed by the processors, implements the steps described in the first aspect of the present invention.

Beneficial effects: in the present invention, according to an actual capacity application requirement, a unified capacity similarity characteristic measurement standard is constructed, a specific evaluation scenario is taken as an object, historical data is taken as a basis, a time period sample set homogenized with the to-be-evaluated time period of the to-be-evaluated object is screened by a hierarchical clustering method, and a corresponding capacity reference value is calculated through a capacity set barycenter of a target sample. The method is close to an actual capacity change trend of an airspace unit, such as an airport, a sector, and the like, and can obtain an accurate capacity reference value according to an operating characteristic of the to-be-evaluated object in the to-be-evaluated time period, thus providing objective and reliable data support for subsequent theoretical research and system application in the fields of flow control and airspace management.

### BRIEF DESCRIPTION OF THE DRAWINGS

FIG. 1 is an overall flow chart of a capacity evaluation method based on a historical capacity similarity characteristic according to the present invention;

FIG. 2 is a detailed flow chart of the capacity evaluation method based on the historical capacity similarity characteristic according to an embodiment of the present invention; and

FIG. 3 is a schematic diagram of a capacity similarity characteristic evaluation index set according to an embodiment of the present invention.

### DETAILED DESCRIPTION

The technical solutions of the present disclosure are further described hereinafter with reference to the accompanying drawings.

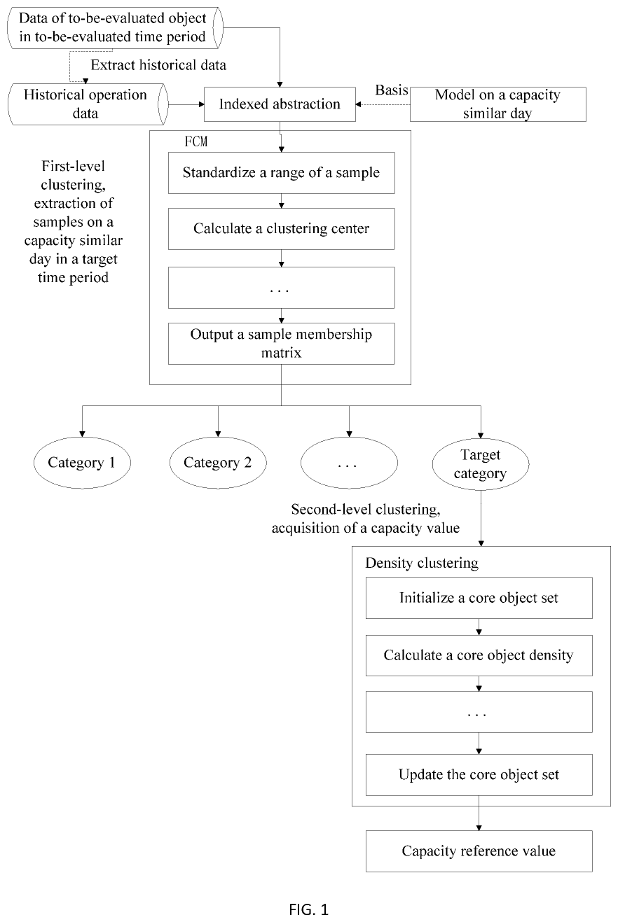

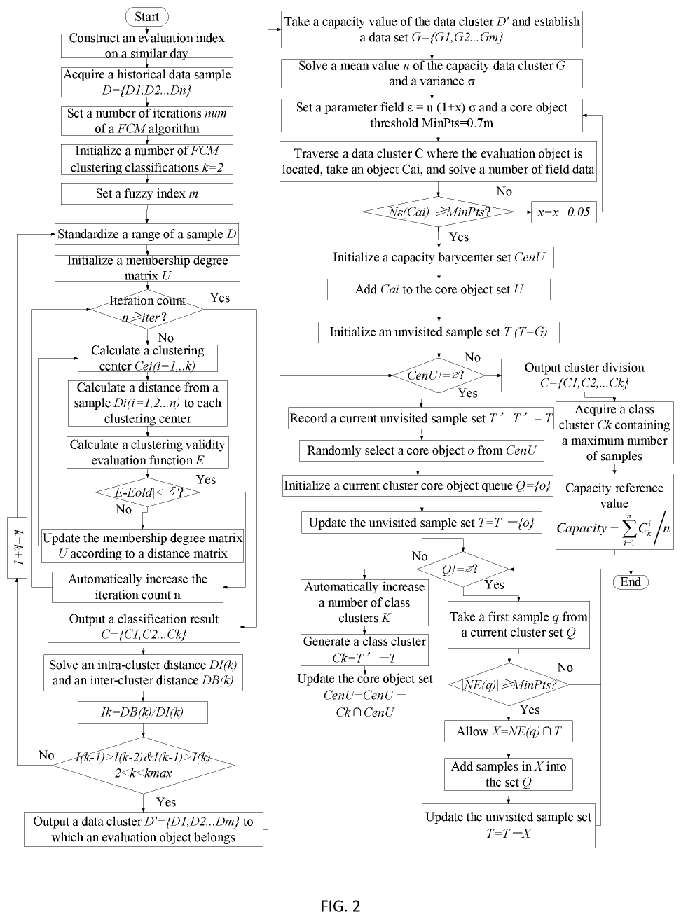

With reference to FIG. 1 and FIG. 2, in an embodiment, a capacity evaluation method based on a historical capacity similarity characteristic includes the following steps.

Step 1: according to different types of airspace units, combined with a capacity influence factor in an actual operating process, constructing a capacity similarity characteristic model.

The capacity similarity characteristic model includes three categories of index sets, including a structural factor, an operating factor, and an emergency factor.

The structural factor refers to statistical analysis performed on a to-be-evaluated object from a perspective of a complex network after abstracting the to-be-evaluated object as a weighted network, which characterizes a relationship between a static characteristic and a capacity of the airspace unit. A node of the network is a key point in an evaluation object, which is generally an end point of a route segment. An edge of the network is a flight route between the nodes, and a weight of the edge is a flow between the nodes in a statistical time period. An index set of the structural factor is Des={K,P,De}, wherein a non-linear coefficient K is an mean value of a ratio of an actual flight distance to a spatial distance between an origin and a destination of a route of a flight in a statistical time period, with a calculation formula of

$$K = \frac{{\sum }_{f = 1}^{m} \frac{{\sum }_{i = 1}^{n} {d}_{fi}}{{d}_{min}}}{m} ,$$

m represents a number of flights flying in the evaluation object in the statistical time period, n represents a number of route segments through which an f^{th} flight flies, d_{fi} represents a distance of the route segment i through which the f^{th} flight flies, and dₘᵢₙ represents the spatial distance between the origin and the destination of the flight route; a node pressure P represents a mean value of a flow passing through a key point in the statistical time period, with a calculation formula of

$$P = \frac{{Σω}_{k}}{num} ,$$

ωₖ represents a flight flow passing through a way point k in unit time, and num represents a number of nodes; a mean value of a node degree De represents a complexity of an airspace structure, with a calculation formula of

$$De = \frac{{\sum }_{i}^{num} {de}_{i}}{num} ,$$

num represents a number of nodes, and deᵢ represents a number of route segments connected with a way point i. The higher the mean value of the node degree De is, the more complex the structure of the airspace is.

The operating factor refers to a macro operating situation of the to-be-evaluated object in a to-be-evaluated time period in a case of a specific flight plan, which characterizes a relationship between a dynamic characteristic and the capacity of the to-be-evaluated object. An index set of the operating factor is Dyn={F,T_{d}}, a time period flow F refers to a number of flights entering the to-be-evaluated object in the statistical time period; an average delay time refers to a delay time of the flight in the to-be-evaluated object in the to-be-evaluated time period, with a calculation formula of

$${T}_{d} = \frac{{\sum }_{i = 1}^{F} {t}_{i}^{d}}{F} ,$$

tᵢ^{d} represents a delay time of a flight 1, which is a difference between a planned flight time and an actual flight time of the flight i in the to-be-evaluated object.

The emergency factor refers to quantitative measurement on an influence of an emergency on the operation of the to-be-evaluated object, which characterizes a relationship between a random characteristic and the capacity of the to-be-evaluated object. An index set of the emergency factor is Out={ρ,R}, ρ represents a weather blocking degree, and R represents a capacity decrease rate. Indexes of the emergency factor of the present invention include the weather blocking degree ρ and the capacity decrease rate R. Since the emergency factor is usually statistically measured by a special institution, has a professional and complicated calculation process, and is not a research focus of the present invention, calculation processes of the weather blocking degree p and the capacity decrease rate R are briefly described herein. Firstly, a weather radar echogram is acquired, then a coverage relationship with the to-be-evaluated object is judged, and finally, a ratio of an available throughput to a total throughput is calculated by a max-flow and min-cut method, which is namely the weather blocking degree. The capacity decrease rate refers to determination of a capacity decrease ratio by manual consultation according to the weather blocking degree.

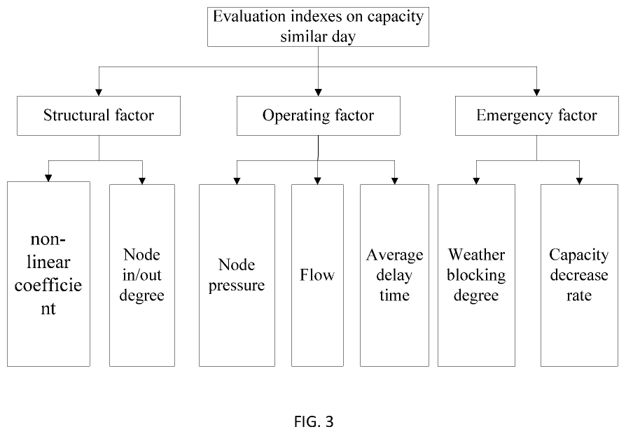

To sum up, the capacity similarity characteristic evaluation index set of the present invention is T={K,P,De,F,T_{d},ρ,R}, as shown in FIG. 3.

Step 2: classifying capacity samples based on self-adaptive fuzzy C-means clustering.

The purpose of classifying the capacity samples is to select a sample set having a similar capacity characteristic with the to-be-evaluated object in the to-be-evaluated time period from historical operation data, so as to provide a data basis for capacity calculation.

Index statistics of different time periods is performed on historical operation flight path data (a selection duration of the historical data is usually 1 year) of the to-be-evaluated object (airspace units including an airport, a sector, and other types) and flight path data of the to-be-evaluated time period according to the capacity similarity characteristic index set to form a capacity similarity characteristic index set matrix D. A number of columns is a number of capacity similarity characteristic indexes, a number of rows is a number of time period samples, and a duration of the different time periods is a time granularity of capacity evaluation (which is usually 15 minutes, 30 minutes, and 60 minutes). The matrix D is clustered in behavior unit to obtain a cluster to which the to-be-evaluated time period of the to-be-evaluated object belongs as a target sample set.

Self-adaptive fuzzy C-means clustering is used in the present invention for category division. A fuzzy C-means algorithm (FCM) is a clustering algorithm based on fuzzy division, with a core idea of maximizing a similarity between objects divided into the same cluster, while minimizing a similarity between objects in different clusters. Compared with a clustering algorithm of hard division, the FCM can more objectively reflect a relationship between factors in an objective world. Specifically, the following steps are included.

Step 2.1: initializing parameters of the fuzzy C-means clustering algorithm.

In order to eliminate an influence of different index dimensions on a clustering result, a range of the matrix D needs to be standardized first, with a specific method of taking a maximum valued dᵥₘₐₓ and a minimum value dᵥₘᵢₙ in a v(v=1, 2 . . . t)^{th} column of the data matrix D, and then a standard range processing formula of the set D is:

$${d}_{uv} = \frac{{d}_{uv} - {d}_{min}}{{d}_{vmax} - {d}_{vmin}} ,$$

(u=1, 2 . . . n, v=1, 2 . . . t). In the formula, dᵤᵥ represents an element in a u^{th} row and a v^{th} column of the matrix D, n represents a number of rows of the matrix, which is namely a total number of sample data, and t represents a number of columns of the matrix, which is namely a number of capacity similarity characteristic indexes contained in sample data in each time period, and a value of t is 7 in the embodiment of the present invention.

A fuzzy index m∈[1,∞) needs to be set in the FCM clustering algorithm, the fuzzy index is a parameter constraining a fuzzy degree in classification, and when there is no special requirement, a value of m is generally 2.

A stable classification threshold δ∈[0,1) needs to be set for the FCM clustering algorithm, and the stable classification threshold is used for judging whether a current classification result is stable. If a difference between a value function of the current classification result and a value function of a previous classification result is less than δ, the current classification is deemed to be stable compared with the previous classification. Otherwise, the current classification is deemed to be unstable, and then δ=1×10⁻⁴ is set in the embodiment of the present invention.

A number of classifications iter ∈[1,∞) needs to be set for the FCM clustering algorithm, since the fuzzy C-means algorithm is a clustering algorithm of fuzzy division, whether the classification result reaches a stable state needs to be judged by whether iter stable classifications are reached, so as to finish an algorithm flow. A value of iter is 20 in the embodiment of the present invention.

According to the FCM clustering algorithm, a belonging degree to a certain class cluster is judged according to a membership degree of each object to each classification, wherein a membership degree matrix U is a k×n order matrix, k is a set number of division categories, and n is a total number of samples. The membership degree matrix U is initialized with data between (0 and 1), and a constraint condition

$${\sum }_{i = 1}^{k} {u}_{ij} = 1 ,$$

{j=1, . . . , n is met. Therefore, before classification by the FCM clustering algorithm, the number of classifications k needs to be determined first, and step 2.2 is executed.

Step 2.2: determining the number of classifications of the capacity samples.

In a traditional FCM clustering algorithm, the number of classifications k is mainly set manually, which is greatly interfered by subjective factors. In the present invention, the number of classifications is adaptively determined by an extreme value discrimination method, so that a problem of inaccurate classification caused by manual intervention is avoided. A specific algorithm flow includes:

(2.2.1) setting a number of initialized classifications to be k=2;

(2.2.2) clustering samples, and executing step 2.3 to obtain k sample clusters, if k<=3, which does not meet an extreme value judgment condition, automatically increasing a k value; and if k>4, performing extreme value judgment on the current clustering result, and executing step (2.2.3);

(2.2.3) calculating an intra-cluster distance DI(k) and an inter-cluster distance DB(k) of each sample cluster, wherein a mean value of the intra-cluster distance DI(k) represents a mean value of a distance between samples in the data cluster, with a calculation method of

$$DI ( k ) = \frac{{\sum }_{c = 2}^{k} {\sum }_{i = 1}^{{n}_{k}} {d}_{ci}}{k} ,$$

in the formula, d_{ci} represents a Euclidean distance between a sample Dᵢ in the same data cluster and a clustering center c_{c}, nₖ represents a number of samples in a k^{th} cluster; and the inter-cluster distance DB(k) represents a distance between different data cluster centers, with a calculation method of

$$DB ( k ) = \frac{{\sum }_{i = 2}^{k} {\sum }_{j = 2}^{k} {d}_{cij}}{k} ,$$

in the formula, d_{cij} represents a Euclidean distance between a clustering center cᵢ and a clustering center cⱼ; and

(2.2.4) defining a ratio I(k)=DB(k)/DI(k), if I(k)>I(k−1) and I(k)>I(k+1), then setting a number of clusters to be k, otherwise, automatically increasing the k value, and returning to step (2.2.3).

The samples are clustered with the modified k value, and step 2.3 is executed.

Step 2.3: performing fuzzy C-means clustering to obtain a class cluster to which the to-be-evaluated object belongs.

According to the membership degree matrix U, a k^{th} clustering center of the current classification may be obtained by a formula

$${c}_{ei} = \frac{{\sum }_{j = 1}^{n} {u}_{ij}^{m} {x}_{j}}{{\sum }_{j = 1}^{n} {u}_{ij}^{m}} ,$$

(i=1, 2 . . . k), wherein xⱼ represents an element in a j^{th} row of a matrix D, and uᵢⱼ^{m} represents m^{th} power of uᵢⱼ^{m}, and a distance dᵢⱼ from n data samples to each clustering center may be respectively obtained by a Euclidean distance formula. On the foregoing basis, a value function J is calculated, with a formula of

$$J ( U , {c}_{1} , … , {c}_{k} ) = {\sum }_{i = 1}^{k} {J}_{i} = {\sum }_{i = 1}^{k} {\sum }_{j}^{n} {u}_{ij}^{m} {d}_{ij}^{2} .$$

If a difference between a value function of the current classification result and a value function of a previous classification result is greater than a stable classification threshold δ, the current clustering operation improves the classification result, there is a room for further improvement, a number of continuous stable clustering times cnt is reset to be 0, the membership degree matrix U is updated, and clustering is performed again, with an updating formula for the membership degree matrix of:

$${u}_{ij} = \frac{1}{{\sum }_{x = 1}^{k} {( \frac{{d}_{ij}}{{d}_{xj}} )}^{2 / ( m - 1 )}} , {d}_{xj}$$

represents the Euclidean distance from the data sample in the j^{th} row to the clustering center, and step 2.3 is executed. If the difference between the value function of the current classification result and the value function of the previous classification result is less than δ, the current classification is stable compared with the previous classification, and the number of continuous stable clustering times cnt is automatically increased. If cnt<iter, the membership degree matrix U is updated, and the clustering is performed again, with the updating formula for the membership degree matrix of:

$${u}_{ij} = \frac{1}{{\sum }_{x = 1}^{k} {( \frac{{d}_{ij}}{{d}_{xj}} )}^{2 / ( m - 1 )}} ,$$

and step 2.3 is executed. If cnt=iter, the FCM clustering algorithm is finished, and the historical sample data are deemed as being divided into different clusters already according to capacity similarity characteristics.

Step 3: calculating a capacity reference value based on a self-adaptive density clustering algorithm.

After classification according to the capacity similarity characteristics, a capacity similarity characteristic cluster of the to-be-evaluated object in the to-be-evaluated time period is obtained, a historical operation capacity of each sample time period in the cluster is acquired to form a capacity set G, and the capacity reference value of the to-be-evaluated object in the to-be-evaluated time period is obtained by performing density clustering on the capacity set G.

A basic idea of the density clustering refers to classification based on a denseness of the data set in space distribution according to sample distribution compactness. Two parameters need to be set for the density clustering algorithm, including a neighborhood radius a and a core object threshold Minpts. A rationality of parameter setting has a great influence on a clustering result. In order to solve a problem of unreasonable parameter setting caused by human factors, the present invention proposes a density clustering algorithm of a self-adaptive radius.

According to the principle of statistics, when a number of data samples is large and conforms to normal distribution, an interval d±σ theoretically contains 68.27% of samples, and an interval d±1.96σ may contain 95.54% of samples.

Since values in the capacity set G do not necessarily conform to the normal distribution, in order to eliminate boundary values and ensure that a core point of the density clustering is located at a center of the data cluster, an initial value of the neighborhood radius is set to be ε=d±σ, and a threshold value of a core object is set to be MinPts=70% m. In the formula, d is a mean value of a historical data capacity, and σ is a standard deviation of a capacity value. Using an idea of infinitesimal method for reference, the density clustering is performed by a self-adaptive radius method.

Specifically, calculating the capacity reference value based on the self-adaptive density clustering algorithm includes the following steps.

Step 3.1: calculating a cluster data barycenter set.

A cluster data barycenter set CenU=ϕ and a unvisited object set T are initialized, and an initial density clustering radius ε=d±σ and a minimum number of data in neighborhood MinPts are set. A point Gᵢ, i=1, 2, . . . num in the cluster is traversed, and num is a number of samples in the cluster. If a number of sample points of Gᵢ in neighborhood in a range of the cluster radius a is greater than MinPts, the point Gᵢ is set as a cluster data barycenter point, and is added into the set CenU. If the number of the sample points of Gᵢ in neighborhood in the range of the cluster radius ε is not greater than MinPts, then the density cluster radius is progressively increased, ε=d±(1+x)σ, (x=x+0.05) is allowed, and G is re-traversed to find the cluster data barycenter point.

After traversing the cluster G to judge the cluster data barycenter point, T=G is allowed, and step 3.2 is executed.

Step 3.2: dividing class clusters.
(a) If CenU=ϕ, the algorithm is finished, and step 3.3 is executed, otherwise, a core object o is randomly selected from the cluster data barycenter set CenU, CenU, CenU=CenU−{o} is updated, a current cluster sample set Cₖ={o} is initialized, an object set contained in the current cluster sample set Cₖ is allowed to be Q={o}, and the unvisited sample set T=T−{o} is updated.
(b) If the current cluster object set is Q=ϕ, step (c) is executed; otherwise, the current cluster object set is Q≠ϕ, a first sample q in Q is taken, a sample set N_{ε}(q) in all neighborhoods in G is found out through the cluster radius ε, X=N_{c}(q)∩T is allowed, samples in X are added into Q, the current cluster sample set Cₖ=Cₖ∪X is updated, the unvisited sample set T=T−X is updated, and step (b) is re-executed, until the cluster object set is Q=ϕ.
(c) After generating the current cluster Cₖ, cluster division C={C₁, C₂, . . . , Cₖ} is updated, the set CenU=CenU−Cₖ∩CenU is updated, and step (a) is executed, until all the data are divided into a certain cluster.

Step 3.3: calculating a capacity value.

After density clustering is performed on a capacity value set in the sample set to which the to-be-evaluated time period of the to-be-evaluated object belongs, an aggregation characteristic of capacity values of the sample set to which the to-be-evaluated time period of the to-be-evaluated object belongs can be determined, so that a capacity reference value

$$Capacity = \frac{{\sum }_{i = 1}^{num} {C}_{k}^{i}}{num}$$

of the to-be-evaluated object in the to-be-evaluated time period is calculated. Cₖ is a cluster with a largest number of samples in the cluster division C={C₁, C₂, . . . , Cₖ}, num is a number of samples in the cluster Cₖ, and Cₖⁱ is an i^{th} element in the cluster.

Based on the same technical concept as the method embodiment, according to another embodiment of the present invention, a computer device is provided. The device includes one or more processors and a memory; and one or more programs, wherein the one or more programs are stored in the memory and configured to be executed by the one or more processors, and the programs, when executed by the processors, implements the steps in the method embodiment.

It should be appreciated by those skilled in this art that the embodiment of the present application may be provided as methods, systems or computer program products. Therefore, the embodiments of the present application may take the form of complete hardware embodiments, complete software embodiments or software-hardware combined embodiments. Moreover, the embodiments of the present application may take the form of a computer program product embodied on one or more computer usable storage media (including but not limited to disk storage, CD-ROM, optical storage, etc.) in which computer usable program codes are included.

The present application is described with reference to the flow charts and/or block diagrams of the method, apparatus (system), and computer program products according to the embodiments of the present disclosure. It should be appreciated that each flow and/or block in the flow charts and/or block diagrams, and combinations of the flows and/or blocks in the flow charts and/or block diagrams may be implemented by computer program instructions. These computer program instructions may be provided to a general purpose computer, a special purpose computer, an embedded processor, or a processor of other programmable data processing apparatus to produce a machine for the instructions executed by the computer or the processor of other programmable data processing apparatus to generate a device for implementing the functions specified in one or more flows of the flow chart and/or in one or more blocks of the block diagram.

These computer program instructions may also be provided to a computer readable memory that can guide the computer or other programmable data processing apparatus to work in a given manner, so that the instructions stored in the computer readable memory generate a product including an instruction device that implements the functions specified in one or more flows of the flow chart and/or in one or more blocks of the block diagram.

These computer program instructions may also be loaded to a computer, or other programmable data processing apparatus, so that a series of operating steps are executed on the computer, or other programmable data processing apparatus to produce processing implemented by the computer, so that the instructions executed in the computer or other programmable data processing apparatus provide steps for implementing the functions specified in one or more flows of the flow chart and/or in one or more blocks of the block diagram.

Finally, it should be noted that the above embodiments are only used to illustrate the technical solutions of the present invention, but not to limit the technical solutions. Although the present invention has been described in detail with reference to the above embodiments, those of ordinary skills in the art should understand that modifications or equivalent replacements can still be made to the specific embodiments of the present invention, while any modifications or equivalent replacements without departing from the spirit and scope of the present invention shall be covered by the scope of protection of the claims of the present invention.

What is claimed is:

1. A capacity evaluation method based on a historical capacity similarity characteristic, comprising the following steps of:
for a capacity influence factor in an operating process of an airspace unit, constructing a capacity similarity characteristic model to form a capacity similarity characteristic index set;
acquiring historical data of an evaluation object, on the basis of the capacity similarity characteristic index set, classifying historical data samples of different time periods by a clustering algorithm, and generating a capacity similarity time period sample set to which an evaluation time period of the current evaluation object belongs;
classifying historical capacity values of the capacity similarity time period sample set by a density clustering algorithm, and calculating a capacity reference value on the basis of a maximum class cluster; and
adjusting the capacity of an airspace structure.

2. The capacity evaluation method based on the historical capacity similarity characteristic according to claim 1, wherein the capacity influence factor comprises a structural factor, an operating factor, and an emergency factor, the structural factor is used for characterizing a relationship between a static characteristic and a capacity of the to-be-evaluated object, which refers to statistical analysis performed on the to-be-evaluated object from a perspective of a complex network after abstracting the to-be-evaluated object as a weighted network; the operating factor is used for characterizing a relationship between a dynamic characteristic and the capacity of the to-be-evaluated object, which refers to a macro operating situation of the to-be-evaluated object in a to-be-evaluated time period in a case of a specific flight plan; and the emergency factor is used for characterizing a relationship between a random characteristic and the capacity of the to-be-evaluated object, which refers to quantitative measurement on an influence of an emergency on the operation of the to-be-evaluated object.

3. The capacity evaluation method based on the historical capacity similarity characteristic according to claim 2, wherein an index set of the structural factor is Des={K,P,De}, wherein a non-linear coefficient K is an mean value of a ratio of an actual flight distance to a spatial distance between an origin and a destination of a route of a flight in a statistical time period, with a calculation formula of
$$K = \frac{{\sum }_{f = 1}^{m} \frac{{\sum }_{i = 1}^{n} {d}_{fi}}{{d}_{min}}}{m} ,$$
m represents a number of flights flying in the evaluation object in the statistical time period, n represents a number of route segments through which an f^{th} flight flies, d_{fi} represents a distance of the route segment through which the f^{th} flight flies, and dₘᵢₙ represents the spatial distance between the origin and the destination of the flight route; a node pressure P represents a mean value of a flow passing through a key point in the statistical time period, with a calculation formula of
$$P = \frac{\sum {ω}_{k}}{n u m} ,$$
ωₖ represents a flight flow passing through a way point k in unit time, and num represents a number of nodes; a mean value of a node degree De represents a complexity of the airspace structure, with a calculation formula of
$$De = \frac{{\sum }_{i}^{num} {de}_{i}}{num} ,$$
num represents a number of nodes, and deᵢ represents a number of route segments connected with a way point i;
an index set of the operating factor is Dyn={F,T_{d}}, a time period flow F refers to a number of flights entering the to-be-evaluated object in the statistical time period; an average delay time refers to a delay time of the flight in the to-be-evaluated object in the to-be-evaluated time period, with a calculation formula of
$${T}_{d} = \frac{{\sum }_{i = 1}^{F} {t}_{i}^{d}}{F} ,$$
tᵢ^{d} represents a delay time of a flight i, which is a difference between a planned flight time and an actual flight time of the flight i in the to-be-evaluated object;
an index set of the emergency factor is Out={ρ,R}, ρ represents a weather blocking degree, and R represents a capacity decrease rate; and
an index set of the capacity similarity characteristic is T={K,P,De,F,T_{d},ρ,R}.

4. The capacity evaluation method based on the historical capacity similarity characteristic according to claim 1, wherein the classifying the historical data samples of different time periods by the clustering algorithm, and generating the sample set to which the evaluation time period of the current evaluation object belongs, comprises: performing index statistics of different time periods on historical operation flight path data of the to-be-evaluated object and flight path data of the to-be-evaluated time period according to the capacity similarity characteristic model to form a capacity similarity characteristic index set matrix D, wherein a number of columns is a number of capacity similarity characteristic indexes, a number of rows is a number of time period samples, and a duration of the different time periods is a time granularity of capacity evaluation, and clustering the matrix D in behavior unit by the clustering algorithm to obtain a cluster to which the to-be-evaluated time period of the to-be-evaluated object belongs as a target sample set.

5. The capacity evaluation method based on the historical capacity similarity characteristic according to claim 4, wherein a fuzzy C-means algorithm is employed as the clustering algorithm, and the classifying the capacity samples comprises the following steps of:
(a) initializing parameters of the fuzzy C-means clustering algorithm:
standardizing a range of the matrix D, setting a fuzzy index m∈[1,∞), a stable classification threshold δ∈[0,1), and a number of classification times iter ∈[1,∞), and determining a number of sample classifications k; initialize a membership degree matrix U with data between (0 and 1), and meeting a constraint condition
$${\sum }_{i = 1}^{k} {u}_{ij} = 1 ,$$
∀j=1, . . . , n, wherein n is a total number of sample data;
(b) performing fuzzy C-means clustering:
according to the membership degree matrix U, obtaining a k^{th} clustering center of the classification by a formula
$${c}_{ei} = \frac{{\sum }_{j = 1}^{n} {u}_{ij}^{m} {x}_{j}}{{\sum }_{j = 1}^{n} {u}_{ij}^{m}} ,$$
(i=1, 2 . . . k), wherein xⱼ represents an element in a j^{th} row of a matrix D, obtaining a distance dᵢⱼ from n data samples to each clustering center by a Euclidean distance formula, and on the foregoing basis, calculating a value function J, with a formula of
$$J ( U , {c}_{1} , … , {c}_{k} ) = {\sum }_{i = 1}^{k} {J}_{i} = {\sum }_{i = 1}^{k} {\sum }_{j}^{n} {u}_{ij}^{m} {d}_{ij}^{2} ;$$
if a difference between a value function of the current classification result and a value function of a previous classification result is greater than a stable classification threshold δ, resetting a number of continuous stable clustering times cnt to be 0, updating the membership degree matrix U, and clustering again; and
if the difference between the value function of the current classification result and the value function of the previous classification result is less than the stable classification threshold δ, automatically increasing the number of continuous stable clustering times cnt, if cnt<iter, updating the membership degree matrix U, and clustering again; if cnt=iter, finishing the clustering algorithm, and obtaining different clusters of the historical sample data divided according to capacity similarity characteristics.

6. The capacity evaluation method based on the historical capacity similarity characteristic according to claim 5, wherein a calculation formula of the updated membership degree matrix is
$${u}_{ij} = \frac{1}{{\sum }_{x = 1}^{k} {( \frac{{d}_{ij}}{{d}_{xj}} )}^{2 / ( m - 1 )}} ,$$
and in the formula, dₓⱼ represents a Euclidean distance from a data sample in a j^{th} row to the clustering center.

7. The capacity evaluation method based on the historical capacity similarity characteristic according to claim 5, wherein in step (a), a number of classifications of capacity samples k is adaptively determined by an extreme value discrimination method, which comprises the following steps of:
(1) setting a number of initialized classifications to be k=2:
(2) clustering samples to obtain k sample clusters, if k does not meet an extreme value judgment condition, automatically increasing a k value; and if k meets the extreme value judgment condition, performing extreme value judgment on the current clustering result as follows:
calculating an intra-cluster distance DI(k) and an inter-cluster distance DB(k) of each sample cluster; wherein
$$DI ( k ) = \frac{{\sum }_{c = 2}^{k} {\sum }_{i = 1}^{{n}_{k}} {d}_{ci}}{k} ,$$
d_{ci} represents a Euclidean distance between a sample Dᵢ in the same data cluster and a clustering center c_{c}, nₖ represents a number of samples in a k^{th} cluster; and
$$DB ( k ) = \frac{{\sum }_{i = 2}^{k} {\sum }_{j = 2}^{k} {d}_{cij}}{k} ,$$
d_{cij} represents a Euclidean distance between a clustering center cᵢ and a clustering center cⱼ; and
judging a change condition of a ratio I(k)=DB(k)/DI(k), if I(k)>I(k−1) and I(k)>I(k+1), then setting a number of clusters to be k, otherwise, automatically increasing the k value, and returning to step (2).

8. The capacity evaluation method based on the historical capacity similarity characteristic according to claim 1, wherein a self-adaptive density clustering algorithm is employed as the density clustering algorithm to classify historical capacity values of a target set, which comprises:
(a) calculating a cluster data barycenter set: initializing the cluster data barycenter set CenU=ϕ and an unvisited object set T, setting an initial density cluster radius ε and a minimum number of data in neighborhood MinPts, traversing a point Gᵢ, i=1, 2, . . . num in a cluster, wherein num is a number of samples in the cluster, if a number of sample points of Gᵢ in neighborhood in a range of a cluster radius s is greater than MinPts, setting the point Gᵢ as a cluster data barycenter point, and adding the same into the set CenU; and if the number of the sample points of Gᵢ in neighborhood in the range of the cluster radius s is not greater than MinPts, then progressively increasing the density cluster radius, re-traversing G to find the cluster data barycenter point, and after traversing the cluster G to judge the cluster data barycenter point, allowing T=G, and executing step (b);
(b) dividing the clusters, which comprises the following steps of:
(b1) if CenU=ϕ, finishing the algorithm, and executing step (c), otherwise, randomly selecting a core object o from the cluster data barycenter set CenU, updating the set CenU, CenU=CenU−{o}, initializing a current cluster sample set Cₖ={o}, allowing an object set contained in the current cluster sample set Cₖ to be Q={o}, and updating the unvisited sample set T=T−{o};
(b2) if the current cluster object set is Q=ϕ, executing step (b3); otherwise, allowing the current cluster object set to be Q≠ϕ, taking a first sample q in Q, finding out a sample set N_{ε}(q) in all neighborhoods in G through the cluster radius ε, allowing X=N_{ε}(q)∩T, adding samples in x into Q, updating the current cluster sample set Cₖ=Cₖ∪X, updating the unvisited sample set T=T−X, and executing step (b2);
(b3) after generating the current cluster Cₖ, updating cluster division C={C₁, C₂, . . . , Cₖ}, updating the set CenU=CenU−Cₖ∩CenU, and executing step (b1); and
(c) calculating a capacity value:
$$Capacity = \frac{{\sum }_{i = 1}^{num} {C}_{k}^{i}}{num}$$
wherein Cₖ is a cluster with the largest number of samples in the cluster division C={C₁, C₂, . . . , Cₖ}, num is a number of samples in the cluster cₖ, and Cₖⁱ is an i^{th} element in the cluster.

9. A computer device, comprising:
one or more processors and a memory; and one or more programs, wherein the one or more programs are stored in the memory and configured to be executed by the one or more processors, and the programs, when executed by the processors, implements the steps of the method according to any one of claim 1.
